(19) United States
(12) Patent Application Publication
(10) Pub. No.: US 2026/0338957 A1
(43) Pub. Date: Oct. 29, 2026

(54) Identifying object motion using Laser speckle

(71) Applicant: APPLE INC., Cupertino, CA (US)

(72) Inventors: Moshe Laifenfeld, Haifa (IL); Dan Nussinson, Haifa (IL)

(21) Appl. No.: 19/734,057

(22) Filed: Jul. 8, 2026

Related U.S. Application Data
(63) Continuation of application No. 17/838,218, filed on Jun. 12, 2022, now Pat. No. 12,710,541.
(60) Provisional application No. 63/235,742, filed on Aug. 22, 2021.

(51) Int. Cl. G01S 17/894; G01B 11/22; G01S 7/481; G01S 7/4865; G01S 7/497; G08B 21/18

(52) U.S. Cl. CPC G01S 17/894; G01B 11/22; G01S 7/4814; G01S 7/4816; G01S 7/4865; G01S 7/497; G08B 21/187

(57) ABSTRACT

Optical sensing apparatus includes a light source configured to emit coherent light toward a scene and an array of detectors configured to detect reflected light including a speckle pattern created by scattering of the coherent light from an object. Processing circuitry is configured to process signals output by the detectors during multiple time intervals to identify changes in the speckle pattern between successive time intervals and to determine, based on the identified changes, whether the object is stationary or mobile.

### CROSS-REFERENCE TO RELATED APPLICATION

This application is a continuation of U.S. Patent Application 17/838,218, filed Jun. 12, 2022, which claims the benefit of U.S. Provisional Patent Application 63/235,742, filed Aug. 22, 2021, which is incorporated herein by reference.

### FIELD OF THE INVENTION

The present invention relates generally to depth mapping, and particularly to devices and methods for depth mapping based on sensing of time of flight (ToF).

### BACKGROUND

Time-of-flight (ToF) imaging techniques are used in many depth mapping systems (also referred to as 3D mapping or 3D imaging systems). In direct ToF techniques, a light source, such as a pulsed laser, directs pulses of optical radiation toward the scene that is to be mapped, and a high-speed detector senses the time of arrival of the radiation reflected from the scene. (The terms “light” and “illumination,” as used in the context of the present description and in the claims, refer to optical radiation in any or all of the visible, infrared, and ultraviolet ranges.) The depth value at each pixel in the depth map is derived from the difference between the emission time of the outgoing pulse and the arrival time of the reflected radiation from the corresponding point in the scene, which is referred to as the “time of flight” of the optical pulses. The radiation pulses that are reflected back and received by the detector are also referred to as “echoes.”

Some ToF-based depth mapping systems use detectors based on single-photon avalanche diode (SPAD) arrays. SPADs, also known as Geiger-mode avalanche photodiodes (GAPDs), are detectors capable of capturing individual photons with very high time-of-arrival resolution, of the order of a few tens of picoseconds. They may be fabricated in dedicated semiconductor processes or in standard CMOS technologies. Arrays of SPAD sensors, fabricated on a single chip, have been used experimentally in 3D imaging cameras.

For efficient detection, SPAD arrays may be integrated with dedicated processing circuits. For example, U.S. Patent Application Publication 2017/0052065, whose disclosure is incorporated herein by reference, describes a sensing device that includes a first array of sensing elements (such as SPADs), which output a signal indicative of a time of incidence of a single photon on the sensing element. A second array of processing circuits are coupled respectively to the sensing elements and comprise a gating generator, which variably sets a start time of the gating interval for each sensing element within each acquisition period, and a memory, which records the time of incidence of the single photon on each sensing element in each acquisition period. A controller processes a histogram of respective counts over different time bins for each sensing element so as to derive and output a respective time-of-arrival value for the sensing element.

U.S. Patent Application Publication 2021/0165083, whose disclosure is incorporated herein by reference, describes a configurable array of single-photon detectors. An array of single-photon detectors, such as SPADs, are disposed on a semiconductor substrate and output electrical pulses in response to incident photons. An array of counters, also disposed on the semiconductor substrate, count the electrical pulses output by the single-photon detectors. Routing and aggregation logic on the substrate is able to vary the configuration of the counters, relative to the detectors, in response to external control signals, and specifically to connect different groups of the single-photon detectors to different counters.

### SUMMARY

Embodiments of the present invention that are described hereinbelow provide improved devices and methods for ToF-based depth mapping.

There is therefore provided, in accordance with an embodiment of the invention, an optical sensing device, including a light source, which is configured to emit one or more beams of light pulses toward a scene, and an array of single-photon detectors, which are configured to output electrical pulses in response to photons that are incident thereon. Light collection optics are configured to form an image of the scene on the array. Processing circuitry, is configured to count the electrical pulses output by the single-photon detectors during multiple time intervals following each of the light pulses, to detect, responsively to the counted pulses, an object located less than 10 cm away from the array that reflects at least one of the beams onto a group of the single-photon detectors, to make a comparison between respective counts of the electrical pulses output by the single-photon detectors in the group during a specified time interval immediately following each of a plurality of the light pulses, and to ascertain, responsively to the comparison, whether the object reflecting the at least one of the beams is fixed to the device or separate from the device.

In some embodiments, the processing circuitry is configured to estimate, responsively to counts of the electrical pulses received from the single-photon detectors during the multiple time intervals, times of flight of the photons to and from points in the scene and to generate a three-dimensional map of the scene based on the times of flight. In a disclosed embodiment, the processing circuitry is configured to detect the object by identifying an area in the scene from which the estimated times of flight of the photons are less than a predefined minimum value.

Additionally or alternatively, the light source includes at least one laser, and the processing circuitry is configured to detect, based on the comparison, changes in a speckle pattern that is scattered from the object.

In some embodiments, the processing circuitry is configured to compute differences between respective first and second numbers of the electrical pulses output by each of the single-photon detectors in the group that were counted in the specified time interval following first and second sequences of the light pulses, and to make the comparison by comparing the differences to a predefined threshold. In a disclosed embodiment, the processing circuitry is configured to identify the object as being separate from the device when at least one of the differences is greater than the predefined threshold, and otherwise to identify the object as being fixed to the device.

Additionally or alternatively, the processing circuitry is configured to issue an alarm indicating a malfunction of the device upon ascertaining that the object is fixed to the device.

There is also provided, in accordance with an embodiment of the invention, a method for optical sensing, which includes emitting one or more beams of light pulses from a depth-sensing device toward a scene. An image of the scene is formed on an array of single-photon detectors in the depth-sensing device. Electrical pulses output by the single-photon detectors in response to photons that are incident thereon are counted during multiple time intervals following each of the light pulses. Responsively to the counted pulses, an object located less than 10 cm away from the array that reflects at least one of the beams onto a group of the single-photon detectors is detected. A comparison is made between respective counts of the electrical pulses output by the single-photon detectors in the group during a specified time interval immediately following each of a plurality of the light pulses. It is ascertained, responsively to the comparison, whether the object reflecting the at least one of the beams is fixed to the device or separate from the device.

The present invention will be more fully understood from the following detailed description of the embodiments thereof, taken together with the drawings in which:

### BRIEF DESCRIPTION OF THE DRAWINGS

FIG. 1 is a schematic side view of a depth mapping device, in accordance with an embodiment of the invention; and

FIG. 2 is a flow chart that schematically illustrates a method for processing signals generated by a depth mapping device, in accordance with an embodiment of the invention.

### DETAILED DESCRIPTION OF EMBODIMENTS

ToF-based optical sensing devices generally work best in mapping target scenes at relatively long ranges, in which the times of flight of photons to and from the scene are in the tens of nanoseconds or more. At shorter distances, the ToF measurements can be distorted due to the high intensity of the reflected light pulses, as well as by stray reflections of the transmitted beam. Such stray reflections may originate from objects that are fixed to the device, for example from surfaces within the housing of the device or from smudges and scratches on an optical surface of the device, such as on the external cover window of the device.

Stray reflections onto a group of single-photon detectors in an area of a detector array can mask the signals from actual objects in the scene that are imaged onto that area. It is therefore important to identify stray reflections and take remedial action when possible (such as cleaning a smudge or repairing the sensing device). It can be difficult, however, to distinguish the effects of such stray reflections from photons that are reflected from nearby objects in the scene, for example objects less than 10 cm from the device: Both stray reflections and reflections from nearby objects give rise to strong output signals from the single-photon detectors in a time interval that immediately follows each of the light pulses emitted by the light source in the sensing device, and the detectors are generally unable to resolve the small temporal difference between the two types of reflections.

Embodiments of the present invention that are described herein address this problem using the variations that occur (or do not occur) in the signals output by the single-photon detectors in the area of the array in question. These embodiments are based on the observation that reflections from objects that are fixed to the sensing device, whether internally or externally, will be static over time, whereas reflections from objects that are separate from the device will vary due to movements of the objects and/or of the device itself. In particular, when the light pulses directed toward the scene are generated by a laser or lasers, the light scattered from the object will form a speckle pattern. Due to the random nature of the speckle pattern, even very small movements of the object or of the device will cause significant changes in the pattern. By comparing the counts of electrical pulses output by the single-photon detectors in response to successive light pulses, it is possible to detect these changes and thus to ascertain whether the object in question is fixed to the device or separate from the device.

Thus, the embodiments described below provide a sensing device comprising a light source, which emits one or more beams of light pulses toward a scene, and an array of single-photon detectors, which output electrical pulses in response to incident photons. Light collection optics form an image of the scene on the array. For purposes of depth mapping, processing circuitry counts the electrical pulses output by the single-photon detectors during multiple time intervals following each of the light pulses.

Based on the counted pulses, the processing circuitry detects an object located close to the array of single-photon detectors, for example less than 10 cm away, which reflects at least one of the beams onto a group of the single-photon detectors. (A large count of pulses in a time interval immediately following each light pulse is indicative of such a nearby object.) The processing circuitry makes a comparison between respective counts of the electrical pulses that are output by the single-photon detectors in this group during a specified time interval, i.e., within a certain time window immediately following each of a sequence of the light pulses. Based on this comparison, the processing circuitry ascertains whether the object is fixed to the device or separate from the device.

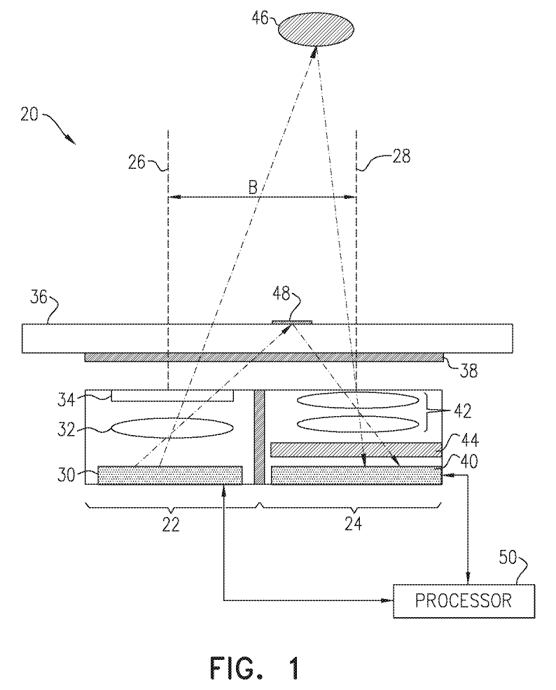

FIG. 1 is a schematic side view of a depth mapping device 20, in accordance with an embodiment of the invention. Device 20 comprises a light source, identified as a transmitting (Tx) laser projector 22, and a receiving (Rx) camera 24, with respective optical axes 26 and 28 that are offset transversely by a baseline offset B, as shown in the figure.

Tx laser projector 22 comprises an array 30 of emitters, such as a monolithic array of vertical-cavity surface-emitting lasers (VCSELs), which emit respective beams of light pulses. Collimating optics 32 project these beams at different, respective angles toward corresponding areas of a target scene. To increase the number of projected beams in the pictured embodiment, a diffractive optical element (DOE) 34 splits the projected beam pattern into multiple adjacent or overlapping copies, thus creating a denser pattern of spots extending over the target scene. A cover window 36 of the device includes a filter 38, for example an infrared (IR) filter, in order to prevent light outside the optical working range from exiting and entering the device.

Rx camera 24 comprises an array 40 of single-photon detectors, which are configured to output electrical pulses in response to photons that are incident thereon. In the present embodiment, the sensing elements comprise SPADs, for example, so that the output signals are indicative of respective times of arrival of photons on the sensing elements. Alternatively, the techniques described herein may be applied, mutatis mutandis, to detectors of other types. Light collection optics 42 image the target scene onto the SPAD array, while a bandpass filter 44 blocks incoming light that is outside the emission band of the Tx laser projector.

Each of the beams emitted by Tx laser projector 22 illuminates a corresponding area of the target scene, and light collection optics 42 image this area onto a certain, respective region of SPAD array 40. An array of counters (not shown) count, during respective time intervals, the electrical pulses that are output by respective sets of one or more of the SPADs. Counter circuits that may be used for this purpose are described, for example, in the above-mentioned U.S. Patent Application Publication 2021/0165083. A processor 50 sets the respective time intervals of the counters and estimates times of flight of the photons to and from points in the scene based on the counts of the electrical pulses received from the single-photon detectors during these intervals. Processor 50 generates a three-dimensional map of the scene based on the estimated times of flight.

The counter circuits and processor 50, along with ancillary circuits for pulse aggregation, timing control, and data readout, are referred to collectively in the present description and in the claims as “processing circuitry.” The counters and ancillary circuits are typically implemented in digital logic, while processor 50 comprises a programmable processing unit, operating under the control of suitable software. Alternative implementations will also be apparent to those skilled in the art after reading the present description and are considered to be within the scope of the present invention.

In the example scenario that is shown in FIG. 1, a number of the beams that are emitted by projector 22 are reflected back and focused onto array 40 from a nearby object 46, while other beams are reflected back from a smudge 48 on cover window 36. Object 46 is assumed to be close to device 20, for example less than 10 cm from array 40. Consequently, the photons reflected from object due to any given light pulse from projector 22 will be incident on array 40 less than 1 ns after the light pulse. The electrical pulses output by the SPADs in response to these photons will occur and be counted in a time interval immediately following each of the light pulses. Photons reflected from smudge 48 will also give rise to pulses within this same time interval. Given the temporal width of the light pulses (typically on the order of 1 ns) and the temporal resolution of the counters, processor 50 may be unable to ascertain on the basis of the measured times of flight whether these reflections are from objects that are fixed to device 20, such as smudge 48, or separate from the device, such as object 46.

Methods for resolving this uncertainty, and specifically for identifying whether the source of short-range reflections are due to object 46 or smudge 48 (or some other surface fixed to device 20), are described below. Although these methods are described here, for the sake of convenience and clarity, with specific reference to the structure and components of device 20, the principles of this method may similarly be implemented, mutatis mutandis, in other sorts of ToF-based depth sensing devices. For example, although device 20 in FIG. 1 has a bistatic configuration, the present method may be applied in monostatic devices, as well. All such alternative implementations are considered to be within the scope of the present invention.

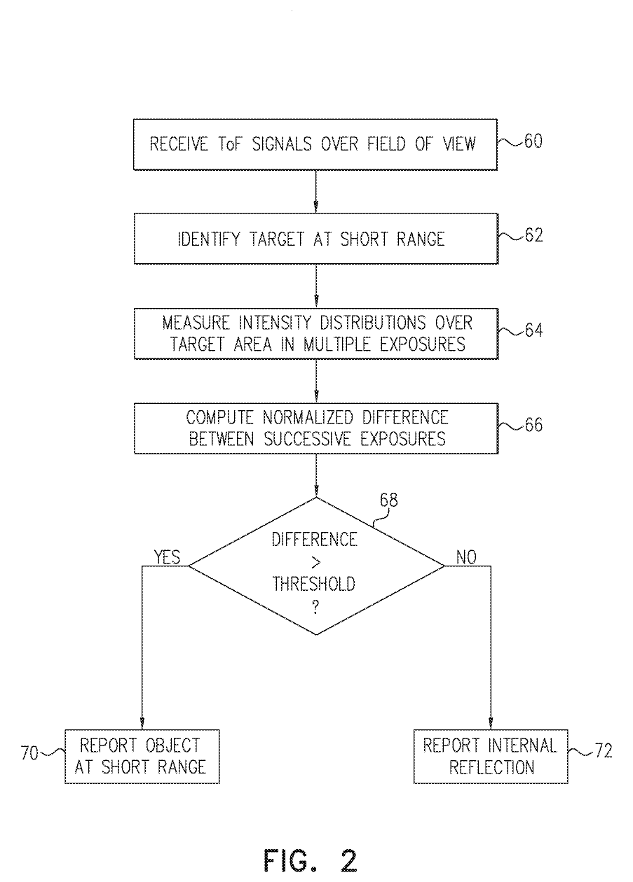

FIG. 2 is a flow chart that schematically illustrates a method for processing signals generated by depth mapping device 20, in accordance with an embodiment of the invention. The method is directed particularly to ascertaining whether nearby objects detected by device 20 are fixed to or separate from the device.

Laser projector 22 emits beams of light toward a scene, and optics 42 image this area onto SPAD array 40. Processor 50 receives counts of the electrical pulses output by the SPADs in a sequence of time intervals, and based on these counts estimates the time of flight of the photons to and from multiple points in the field of view of device 20, at a ToF measurement step 60. In the course of this measurement, processor 50 identifies one or more areas of array 40 in which the counts are concentrated in a time interval immediately following each light pulse, meaning that the estimated times of flight of the photons in this area are less than a predefined minimum value, for example 2 ns. Processor 50 identifies this area of array 40 as corresponding to a target at short range, i.e., the photons received by the SPADs in this area are reflected from an object close to array 40, at a target identification step 62.

In response to this identification, processor 50 sets the counters in this area of array 40 to count the electrical pulses that are output from the SPADs in the area during a specified time interval immediately following each of a sequence of light pulses emitted by laser projector 22. For example, the processor may assign a respective counter to count the electrical pulses that are output individually by each of the SPADs in this group during the specified interval. Processor 50 receives the count of pulses output by each of the SPADs in the group during the specified time interval over a sequence of light pulses, at a multiple exposure measurement step 64. This pulse count is proportional to the intensity of reflections received by each SPAD, and thus to the intensity of the reflections from a respective point on the target that is reflected onto each SPAD.

For example, laser projector 22 may output several trains of light pulses, with a certain null time between successive pulse trains, and processor 50 may then measure the respective pulse count received from each SPAD in the area of interest over each of the pulse trains. In this case, each “exposure” corresponds to one of the pulse trains in the succession. The number of pulses in each pulse trains should be large enough to easily differentiate between speckle noise and shot noise. As shot noise typically increases as the square root of the number of pulses, and speckle noise is linearly proportional to the number of pulses, this condition is easily met by pulse trains of a few thousand pulses.

Processor 50 makes a comparison between the respective counts of the electrical pulses output by the SPADs in the group during the specified time interval immediately following each light pulse. Specifically, in the present embodiment, processor 50 computes differences in the counts of the electrical pulses output by each of the SPADs between different pairs of exposures, at a difference computation step 66. In other words, processor 50 subtracts the counts that were accumulated from each SPAD over different trains of the light pulses. The processor typically normalizes the differences, for example according to the average number of counts received over the pair of exposures (or over the succession of exposures). Alternatively, processor 50 may use other measures for purposes of comparing the pulse counts, for example by constructing histograms of the numbers of counts per temporal bin over the sequence of exposures. Such a histogram may enable more accurate estimation of the signal variations between exposures and create a clearer distinction between speckle noise and shot noise.

Processor 50 compares the count differences found in step 66 to a predefined threshold, at a difference comparison step 68. For example, the processor may choose the largest normalized difference that it found over all of the pairs of exposures among all the SPADs in the group and compare this value to the threshold. Alternatively, the processor may apply a threshold to a certain subset or average of the normalized differences. The threshold may be set, for example, to a small multiple of the standard deviation of the shot noise. When the difference found at step 66 for a given area of array 40 is greater than the threshold, processor 50 identifies this area as receiving reflections from an object that is separate from device 20 (for example, object 46 in FIG. 1), at a separate object identification step. Otherwise, processor 50 identifies the object giving rise to the reflections as being fixed to the device (for example, smudge 48), at an internal reflection identification step 72. The threshold to be applied at step 68, as well the specific mode and parameters of the comparison of the differences in pixel counts that is used at steps 66 and 68, may be chosen and optimized heuristically based on the specific design and performance of device 20.

In some embodiments, the identifications made at steps 70 and 72 are reported in the context of the depth maps output by processor 50. For example, nearby external objects identified at step 70 may be represented in the depth map at their estimated distances from device 20. On the other hand, the areas covered by objects giving rise to internal reflections may be represented in the depth as having unknown depth coordinates. If these latter areas are large and persistent, processor 50 may issue an alarm indicating a malfunction of device 20, for example by outputting a message to a user of the device. The alarm may prompt the user, for example, to inspect and clean cover window 36 if necessary.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Optical sensing apparatus, comprising:
a light source configured to emit coherent light toward a scene;
an array of detectors configured to detect reflected light including a speckle pattern created by scattering of the coherent light from an object; and
processing circuitry configured to process signals output by the detectors during multiple time intervals to identify changes in the speckle pattern between successive time intervals and to determine, based on the identified changes, whether the object is stationary or mobile.

2. The apparatus according to claim 1, further comprising light collection optics configured to form an image of the scene on the array of detectors.

3. The apparatus according to claim 1, wherein the light source is configured to emit light pulses toward the scene, and the processing circuitry is configured to count electrical pulses output by the detectors in response to the light pulses.

4. The apparatus according to claim 3, wherein the detectors comprise single-photon avalanche diodes (SPADs).

5. The apparatus according to claim 3, wherein the processing circuitry is configured to estimate times of flight of photons to and from points in the scene and to generate a three-dimensional map of the scene based on the times of flight.

6. The apparatus according to claim 3, wherein the processing circuitry is configured to compute differences between counts of the electrical pulses output by the detectors during different time intervals and to compare the differences to a predefined threshold.

7. The apparatus according to claim 6, wherein the processing circuitry is configured to determine that the object is mobile when at least one of the differences is greater than the predefined threshold, and to determine that the object is stationary when none of the differences is greater than the predefined threshold.

8. The apparatus according to claim 6, wherein the light source is configured to emit trains of light pulses during the different time intervals, and the processing circuitry is configured to compare counts of the electrical pulses output by the detectors in response to the pulse trains.

9. The apparatus according to claim 1, wherein the processing circuitry is configured to issue an alarm upon determining that the object is stationary.

10. The apparatus according to claim 1, further comprising a cover window through which the coherent light is emitted, wherein the processing circuitry is configured to identify reflections from a surface of the cover window as originating from a stationary object.

11. A method for optical sensing, comprising:
emitting coherent light toward a scene;
detecting reflected light incident on an array of detectors including a speckle pattern created by scattering of the coherent light from an object;
processing signals output by the detectors during multiple time intervals to identify changes in the speckle pattern between successive time intervals; and
determining, based on the identified changes, whether the object is stationary or mobile.

12. The method according to claim 11, further comprising forming an image of the scene on the array of detectors.

13. The method according to claim 11, wherein emitting the coherent light comprises emitting light pulses toward the scene, and wherein processing the signals comprises counting electrical pulses output by the detectors in response to the light pulses.

14. The method according to claim 13, wherein the detectors comprise single-photon avalanche diodes (SPADs).

15. The method according to claim 13, wherein processing the signals comprises estimating times of flight of photons to and from points in the scene and generating a three-dimensional map of the scene based on the times of flight.

16. The method according to claim 13, wherein the processing the signals comprises computing differences between counts of the electrical pulses output by the detectors during different time intervals and comparing the differences to a predefined threshold.

17. The method according to claim 16, wherein determining whether the object is stationary or mobile comprises determining that the object is mobile when at least one of the differences is greater than the predefined threshold, and determining that the object is stationary when none of the differences is greater than the predefined threshold.

18. The method according to claim 16, wherein emitting the light pulses comprises emitting trains of the light pulses during the different time intervals, and wherein processing the signals comprises comparing counts of the electrical pulses output by the detectors in response to the pulse trains.

19. The method according to claim 11, further comprising issuing an alarm upon determining that the object is stationary.

20. The method according to claim 11, wherein the coherent light is emitted through a cover window, and wherein determining whether the object is stationary or mobile comprises identifying reflections from a surface of the cover window as originating from a stationary object.
